(19) United States
(12) Patent Application Publication
(10) Pub. No.: US 2024/0138365 A1
(43) Pub. Date: May 2, 2024

(54) PET TRAINING PAD SYSTEM COMPRISING AN ABSORBENT PAD AND A NATURAL OR SYNTHETIC WAX SHEET

(71) Applicant: FOUR PAWS PRODUCTS, LTD., Neptune City, NJ (US)

(72) Inventors: Glen S. AXELROD, Colts Neck, NJ (US); Ajay GAJRIA, Monmouth Junction, NJ (US)

(21) Appl. No.: 18/495,940

(22) Filed: Oct. 27, 2023

Related U.S. Application Data
(60) Provisional application No. 63/381,151, filed on Oct. 27, 2022.

(51) Int. Cl. A01K 1/015; A01K 1/01

(52) U.S. Cl. CPC A01K 1/0157; A01K 1/0107

(57) ABSTRACT

Pet training pad systems and methods. More specifically, a pet training pad system and method comprising a wax sheet formable into a wax tray and including an absorbent pad to be disposed in the wax tray. The wax sheet may be formed into the wax tray with one or more generally vertical walls. A pet waste absorbent pad is also disclosed.

### CROSS-REFERENCE TO RELATED APPLICATIONS

This application claims the benefit of U.S. provisional patent application Ser. No. 63/381,151, filed Oct. 27, 2022, the entire disclosure of which is incorporated herein by reference.

### FIELD

The present invention generally relates to pet training pad systems and methods. More specifically, the present invention relates to a pet training pad system and method comprising a natural or synthetic wax sheet including an absorbent pad sized to be placed on the sheet surface. The sheet may be configured to be formed with one or more generally vertical walls.

### BACKGROUND

Pet owners often housetrain pets such that the pet does not urinate and/or defecate at an undesirable location within the owner's home. For example, dog owners train their dog to urinate and/or defecate outside the owner's home. In some situations, however, a dog or other pet may not be able to get outside when it needs to relieve itself. To address such situations, a pet owner may train their pet to urinate and/or defecate at a consistent location within their home. For example, a pet owner may train a dog or other animal to urinate and/or defecate on an absorbent pet training pad that is placed at a desired location in the home. Such pet training pads are configured to protect underlying surfaces from urine and feces and are often configured such that the owner can easily clean up and dispose of them once they are soiled.

While pet training pads are widely utilized and can be effective, such pads are generally configured to lay substantially flat on an underlying surface such as a floor. When an animal uses a substantially flat pad, the animal may position itself such that urine and feces are not directed to the center of the pad, but rather towards the periphery of the pad. As a result, animal waste (particularly urine) may flow off the pad before it is absorbed by the pad. The animal waste (particularly urine) that is absorbed by the pad may seep through the bottom layer if there is a relatively large amount absorbed or substantial time passes before the owner can clean up the soiled pad. The resulting mess is inconvenient and unappealing to clean up and may cause damage to the surfaces around or under the pad.

Many modern consumers are making environmentally conscious decisions about the product they purchase. Thus, there remains a need in the art for pet training pads that can better contain animal waste (particularly urine) within the dimensional confines of the pad and can reduce the amount of unsustainable, non-biodegradable waste created by the use of such pads.

### SUMMARY

A pet training pad system comprising an absorbent pad and a natural or synthetic wax sheet having a surface region which releasably engages with the absorbent pad.

A pet training pad system, comprising an absorbent pad; a wax sheet; wherein the wax sheet is formable into a wax tray; and wherein the absorbent pad is disposable in the wax tray.

A pet waste absorbent pad, comprising a top layer; a bottom layer; at least one intermediate layers disposed between the top layer and the bottom layer; wherein the at least one intermediate layer is a wax layer; and wherein the wax layer is formable into a wax tray whereby the absorbent pad is correspondingly formed into an absorbent pad tray.

A method of providing a pet training pad system, comprising providing an absorbent pad and a wax sheet; wherein the wax sheet is formable into a wax tray; and wherein the absorbent pad is disposable in the wax tray.

A method of forming a pet training absorbent pad, comprising providing a pet waste absorbent pad, the absorbent pad comprising a top layer, a bottom layer, at least one intermediate layers disposed between the top layer and the bottom layer, wherein the at least one intermediate layer is a wax layer, and wherein the wax layer is formable into a wax tray whereby the absorbent pad is correspondingly formed into an absorbent pad tray; and forming the wax layer into the wax tray whereby the absorbent pad is correspondingly formed into the absorbent pad tray.

A pet training pad system, comprising an absorbent pad and a natural or synthetic wax sheet having an inner surface region for engagement with the absorbent pad and an outer surface including a plurality of edge regions on the natural or synthetic wax sheet inner surface. The natural or synthetic wax sheet inner surface is configured to releasably engage to the absorbent pad and the plurality of edge regions on the natural or synthetic wax inner sheet are configured to adhere together to provide a generally vertical wall.

A method of providing a pet training pad system. One initially provides a natural or synthetic wax sheet having a surface and an absorbent pad. The absorbent pad is then pressed onto and releasably engaged to the surface of the natural and synthetic wax sheet.

A method of providing a pet training pad system comprising providing a natural or synthetic wax sheet having an inner surface region, an outer surface, at least two corner locations and a plurality of edge regions on the beeswax sheet inner surface. This is followed by application of pressure on the outside surface of the natural or synthetic wax sheet at the at least two corner locations and adhering together the inner surfaces of the natural or synthetic wax sheet at the corner locations and forming a generally vertical wall between the at least two corner locations.

A method of providing a pet training pad system comprising providing a wax sheet having at least two corner locations and at least one edge region; and adhering together surfaces of the wax sheet at the at least two corner locations and forming a generally vertical wall at least two corner locations with the at least one edge region; and disposing a pet training pad on the wax sheet.

### BRIEF DESCRIPTION OF THE DRAWINGS

Features and advantages of this disclosure will become more apparent as the following detailed description proceeds, and upon reference to the drawings, wherein like numerals designate like parts, and in which:

FIG. 1 is an isometric view of an exemplary wax (e.g. beeswax) sheet of the present disclosure.

FIG. 2 illustrates the wax sheet of FIG. 1 in its deployed tray state.

FIG. 3A illustrates the area of the wax sheet of FIG. 1 encircled by reference character 3A in a close-up view.

FIG. 3B illustrates the wax tray of FIG. 2 in a close-up view showing where the typical user will apply pressure to convert the wax sheet of FIG. 1 into the wax tray of FIG. 2.

FIG. 3C illustrates the area of the wax tray of FIG. 2 encircled by reference character 3C in a close-up view.

FIG. 4 illustrates the wax tray of FIG. 2 with the absorbent pad placed within.

FIG. 5 illustrates the wax sheet of FIG. 1 in a cross-sectional view.

FIG. 6 illustrates the wax tray and absorbent pad of FIG. 4 in a cross-sectional view.

FIG. 7 is an isometric view of another exemplary wax (e.g. beeswax) sheet of the present disclosure;

FIG. 8 illustrates another wax sheet in a cross-sectional view.

FIG. 9 illustrates wax incorporated within the absorbent pad.

### DETAILED DESCRIPTION

As noted in the background, pet training pads are currently known. Although such pads can be effective, they typically are configured to lie on an underlying surface such as a floor. When an animal uses the pad, the animal may position itself so that urine and feces are deposited relatively close to a periphery of the pad, rather than at the center of the pad. Also, the urine and/or feces absorbed into the pad can leak through the bottom layer of the pad if the pad becomes oversaturated with a large volume of urine or feces or the saturated pad is not cleaned immediately allowing time for seepage to occur.

With the foregoing in mind, the present disclosure generally relates to a pet training pad system comprising an absorbent pad and a natural or synthetic wax sheet having a surface region for releasable engagement (e.g. releasable bond such as a releasable adhesive bond) with an absorbent pad. In method form, one initially provides a natural or synthetic wax sheet having a surface and an absorbent pad. The absorbent pad is then pressed onto and releasably engaged to the surface of the natural and synthetic wax sheet.

The synthetic or natural wax sheet can preferably be selected from natural or synthetic polymers or macromolecules. Natural polymers or macromolecules therefore include plant-based wax, such as carnauba wax, soy wax, jojoba wax, candelilla wax or rice-bran wax. In addition, one may also preferably utilize a natural animal wax, such as beeswax. Synthetic wax preferably is selected from a hydrocarbon-based wax which therefore includes a polyethylene wax or a paraffin wax. The wax composition/layer of the wax sheet preferably comprises at least 75% of wax by weight, more preferably comprises at least 85% of wax by weight and even more preferably comprises at least 95% of wax by weight. The wax sheet may comprise, essentially consist of or consist of wax.

The synthetic or natural wax herein is such that they provide hydrophobic properties, such as a surface that repels water. In addition, the waxes are such that they are malleable or pliable (formable) at ambient temperatures. Namely they can be pressed or folded into a desired shape by a user. They typically have melting points in the range of 35° C. to 100° C. The synthetic or natural wax sheet herein is also one that itself provides a surface that releasably engages to itself as well as releasably engaging to an applied absorbent pad.

Optionally, one may include additives in the natural or synthetic wax sheet, such as one or more tackifiers, which promotes the formation of surface adhesive bond. Such tackifiers may also be described as increasing the stickiness of the surface of the wax sheet. Preferably, such tackifiers therefore include resins (e.g. rosins and their derivates, terpenes and modified terpenes, aliphatic, cycloaliphatic and aromatic resins (C5 aliphatic resins, C9 aromatic resins, and C5/C9 aliphatic/aromatic resins), hydrogenated hydrocarbon resins, and their mixtures, terpene-phenol resins (TPR, used often with ethylene-vinyl acetate adhesives)), and novolacs. Tackifiers herein may also include pressure sensitive adhesive formulation, that include natural or synthetic rubbers. Tackifiers may preferably be present in the natural or synthetic wax sheet in the range of 1.0% (wt.) to 40.0% (wt.) of the wax sheet, including all individual values and increments therein. For example, the tackifiers may be present at a level 1.0% (wt.) 25.0% (wt.), or at a level of 1.0% (wt.) to 15.0% (wt), or even at a preferred level of 5.0% (wt.) to 25.0% (wt.) of the wax sheet.

Optionally, the wax sheet may, or may not, include a reinforcement disposed in the wax composition of the wax layer. Exemplary reinforcements may, or may not, include randomly dispersed particulate (e.g. random fibers) in the wax composition. Reinforcements may, or may not include, fabric, mesh, screen, membranes, films or other reinforcement layers which may be, for example, woven, non-woven, knitted, porous or non-porous. Thus, the wax sheet, for example, may include randomly dispersed particulate with or without an additionally enforcement layer. Or, for example, the wax sheet may comprise a reinforcement layer with or without additional reinforcement in the form of randomly dispersed particles. Or, for example, the wax sheet may comprise a porous, non-woven or woven layer to the exclusion of the other listed reinforcement layers.

With the foregoing in mind, the present disclosure more preferably relates to a pet training pad system comprising a natural or synthetic wax sheet, having inner and outer surfaces, including edge locations, wherein the edge locations are subsequently transformed into a structure with one or a plurality of generally vertical walls, such as in a tray, wherein an absorbent pad may be placed within such tray. Reference to a tray may be understood as a receptacle with raised edges (generally vertical walls) for containing an absorbent pad.

The natural or synthetic wax sheet therefore preferably has one or more edge locations which can become one or a plurality of generally vertical walls (raised edges) around all or a portion of the beeswax sheet inner surface. The absorbent pad can then be placed and adhered onto the inner surface of the center portion of the tray, generally defined by the formed vertical walls. Accordingly, it can be appreciated that the natural or synthetic wax sheet at a plurality of locations of the inner surfaces (e.g. at selected locations along the edge) may preferably and conveniently be pinched together and adhered together so as to create generally vertical walls, thereby defining a border for the natural or synthetic wax sheet.

One particularly preferred natural or synthetic wax that may be used herein includes beeswax sheet, which is reference to the wax produced by honeybees. An approximate chemical formula for beeswax is C₁₅H₃₂COOC₃₀H₆₁. It contains a relatively high proportion fatty acid esters and alcohols and relatively smaller proportions of hydrocarbons and acids. It has a relatively low melting range of 62° C. to 64° C. The beeswax sheet preferably has a flexural strength between 0.7 MPa and 1.0 MPa and a yield strength between 0.5 MPa to 0.6 MPa. The surfaces of the beeswax are such that they will adhere to itself which as discussed herein, may be relied upon to form generally vertical upstanding wall in the beeswax sheet. In addition, the natural adhesive characteristics of the preferred beeswax surface can be relied upon, as further disclosed herein, to releasable engage an absorbent pad that is placed upon the beeswax surface. The bottom surface of the wax sheet also may provide a slide-resistant surface when placed on an underlying surface, i.e. resists sliding, to stay where it is placed.

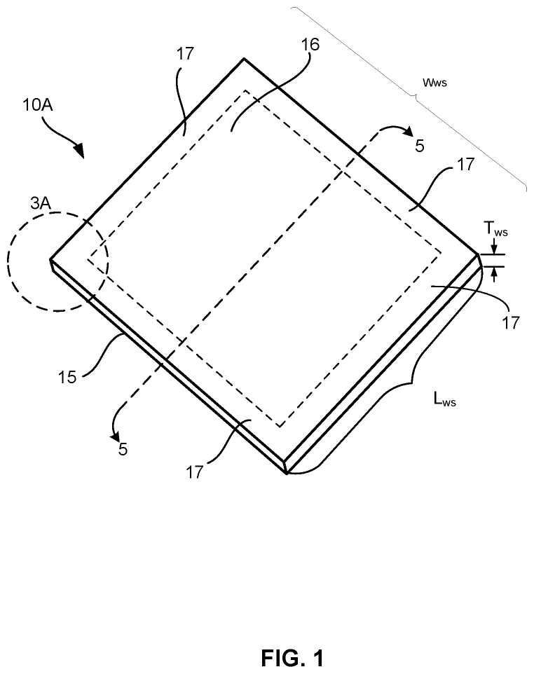

FIG. 1 depicts a preferred embodiment of the natural or synthetic wax sheet 10A (“wax sheet”) which preferably has four sides with length of the wax sheet L_{ws}, a wax sheet width W_{ws} and a thickness for the wax sheet T_{ws}. However, the geometry of the wax sheet can assume any geometry (e.g., square, rectangle, round, triangular, etc.) to accommodate an absorbent pad, also of varying geometry. In a preferred embodiment, the length L_{ws} and width W_{ws} is in the range of 12.0 inches to 45 inches including all individual values and increments therein. The thickness T_{ws} of the wax sheet 10A is preferably in the range of 0.01 inches to 1.0 inches, including all individual values and increments therein. For example, the wax sheet 10A may more preferably have a thickness in a range of 0.1 inches to 0.25 inches. The wax sheet 10A is preferably continuous (non-perforated).

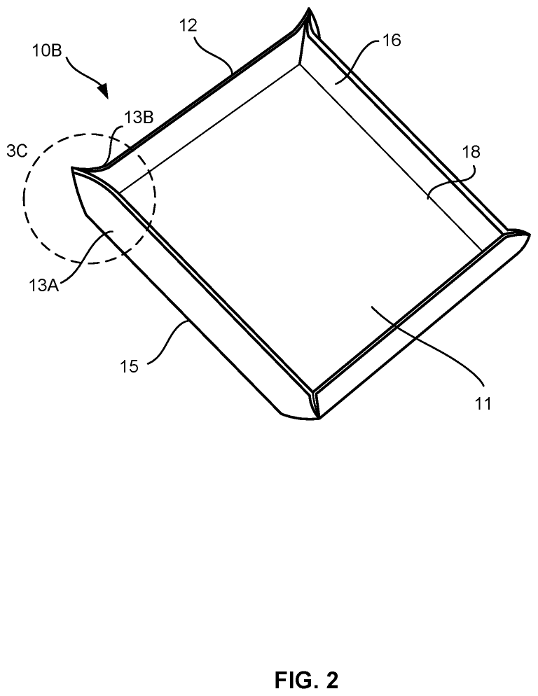

In FIG. 1, the wax sheet 10A is shown with surface 16 that provides (see FIG. 2) an inner surface for the as-formed tray and a bottom surface 15 that provides the outer surface of the as-formed tray. In addition, (perimeter) edge regions 17 are identified on the inner surface 16, which preferably extend inwardly from the outer perimeter edge of the sheet, in the range of 0.2 inches to 3.0 inches, including all individual values and increments therein. These edge regions 17 ultimately are relied upon and turned generally upward to form the generally vertical walls, as disclosed herein.

FIG. 2 depicts the preferred embodiment of FIG. 1 after it has been transformed into a wax tray 10B which preferably has a relatively flat (planar) center region 11 now surrounded by a generally vertical wall 12. As shown in FIG. 2, the wax tray 10B includes inner surface 16, bottom or outer surface 15 and generally vertical walls 12 which vertical walls 12 generally define the center region 11 of the tray. As can therefore be appreciated, the edge regions 17 illustrated in FIG. 1 have now been turned generally upward, such as by bending and/or folding, to form the vertical walls 12.

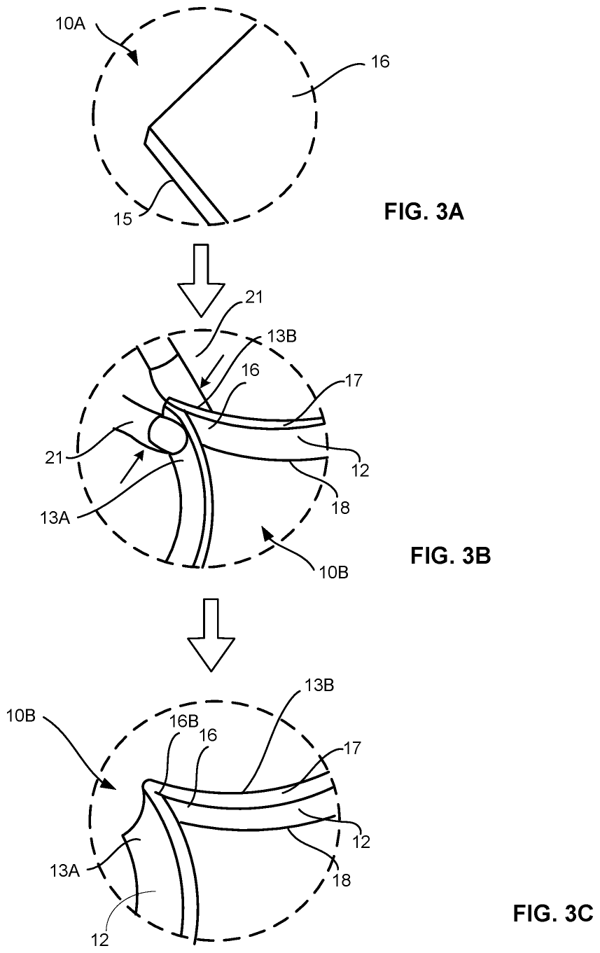

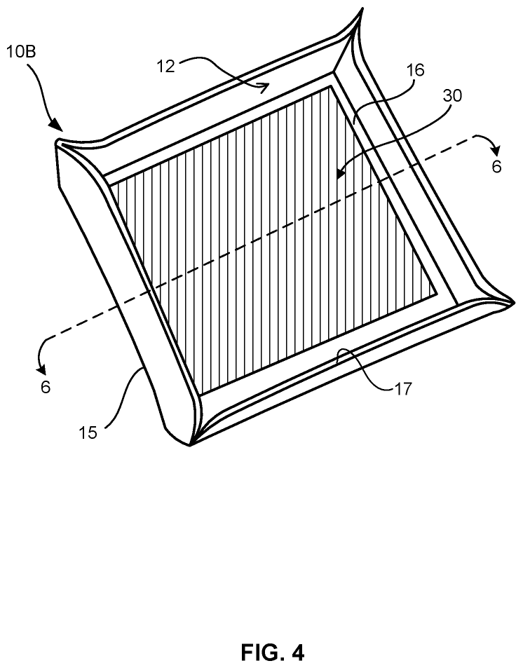

FIGS. 3A-3B illustrate a preferred method of forming the generally vertical walls 12 and how a user can transform the wax sheet 10A into a wax tray 10B. As can be observed, a user may apply pressure to the outside surfaces 13A and 13B at each of the sheet corner locations 20A. FIG. 3A depicts a close-up view of one corner location 20A of wax sheet 10A prior to forming the generally vertical wall 12.

FIG. 3B depicts a typical user's two fingers 21 folding, pinching and applying pressure at the corner location 20A of the wax sheet 10, inwardly on itself so as to form the generally vertical walls 12. As can be seen, the user preferably provides pressure to outside surfaces 13A and 13B, which causes the inner surfaces 16 of the wax sheet to come into contact and adhere to one another. A typical user may conveniently apply a pressure of 10 psi to 75 psi on outside surfaces 13A and 13B, including all individual values and increments therein, such that the corresponding inner surfaces 16 of the wax sheet engage and come into contact. The pressure is also preferably and conveniently applied for a time period of 2.0 seconds to 15.0 seconds, including all individual values and increments therein. Given the nature of the natural or synthetic wax, and as shown in FIG. 3C, the inner surfaces 16 adhere and bond together at 16B thereby leading to formation of a generally vertical wall 12 (see again FIG. 2). That is, the sequence shown in FIGS. 3A, 3B and 3C can be conveniently applied to an opposing corner locations 20A of the wax sheet 10A such that the generally vertical wall 12 is formed. When the remaining corner locations 20A of the wax sheet 10A undergo a similar sequence, the tray with vertical wall sections along all four sides is formed. See again, FIG. 2.

The bond 16B created at the corner locations 20B of the wax tray 10B is therefore observed to be relatively and sufficiently strong to maintain the formation of the generally vertical position of the walls 12. See again FIG. 2. In the event that the bond 16B undergoes weakening with time, the user may again simply repeat the sequence in FIGS. 3A-3C to ensure that the vertical walls are retained. As such, in light of the foregoing, it may be understood that the two-dimensional corners 20A of the two-dimensional (flat) wax sheet 10A are transitioned into three-dimensional corners 20B of the three-dimensional wax tray 10B.

The now remaining center region 11 of the wax tray 10B (see FIG. 2) may therefore be properly sized to receive and now releasably adhere and contain an inserted absorbent pad 30. See FIG. 4. The generally vertical wall 12 is preferably formed such that the vertical wall is continuous about the entire perimeter of the tray 10B. Such generally vertical wall 12 can preferably now act as a barrier to impede the passage of animal waste—particularly urine—from within the dimensional confines of the wax tray 10B into the surrounding environment. Reference to the dimensional confines of the wax tray 10B should be understood as the space in the center region 11 surrounded by the generally vertical wall 12.

FIG. 4 depicts the preferred embodiment of FIG. 2 with absorbent pad 30 now placed (disposed) within wax tray 10B on wax sheet inner surface 16. As alluded to above, the overall shape and size of the center region 11 of the wax tray 10B preferably provides an area in which an absorbent pad 30 may be releasably adhered to the wax surface and therefore be contained and immobilized on the inner surface 16 of the wax tray 10B. The absorbent pad 30 may itself have one or more sides, preferably having the same number of sides of the wax sheet 10A. The sides of the absorbent pad 30 preferably has a length that is less than the length Lws and width Wws of wax sheet so that absorbent pad 30 is fully contained within wax tray 10B. However, it is also contemplated that the absorbent pad 30 may have a length and width that is greater than the center region 11, so that a portion of the absorbent pad 30 may also adhere to all or a portion of the inner surface 16 of the generally vertical wall 12. Accordingly, the absorbent pad 30 can assume a variety of geometries and preferably covers 50% to 100% or more of the wax tray 10B inner surface, including all individual values and increments therein. The absorbent pad 30 itself may preferably have one or more layers, preferably one or more of an absorbent layers, an attractant layer, a scent masking layer, and/or a bottom nonpermeable layer.

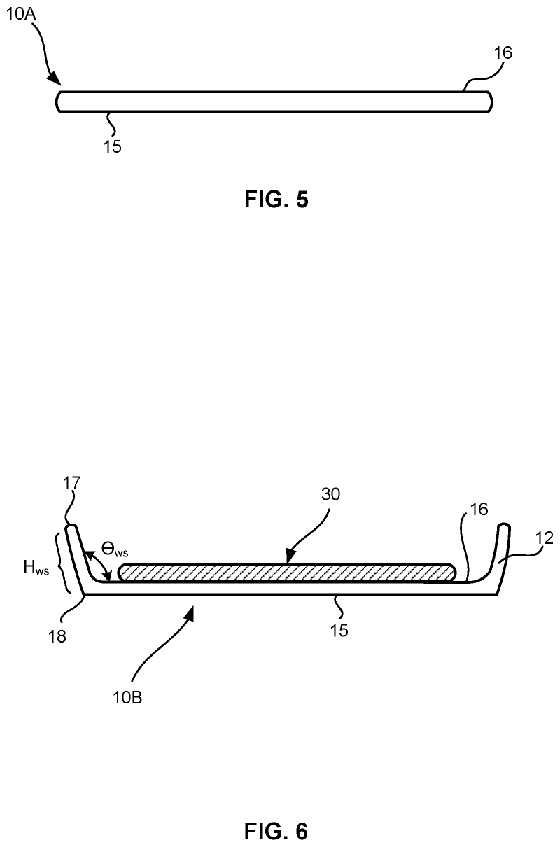

FIG. 5 illustrates the preferred embodiment of FIG. 1 in cross sectional view. FIG. 6 illustrates the preferred embodiment of FIG. 4 in cross-sectional view. The formed and generally vertical wall 12 of the wax sheet preferably has a height H_{ws} in the range of 0.2 inches to 3.0 inches, including all individual values and increments therein. The generally vertical wall 12 preferably intersects with the center region 11 of the wax tray 10B and forms a relative angle θ_{ws} in the range of 70° to 120° with the center region 11. As can be seen in FIG. 6, the relative angle θ_{ws} is the angle formed between the identified inner surface 16 of the central region 11 wax sheet and the inner surface 16 of the vertical wall 12. Stated another way generally vertical wall 12 may be at an angle of 90 degrees (i.e. perfectly perpendicular to the central region 11) plus or minus 20 degrees (90°±20°) to the center region 11.

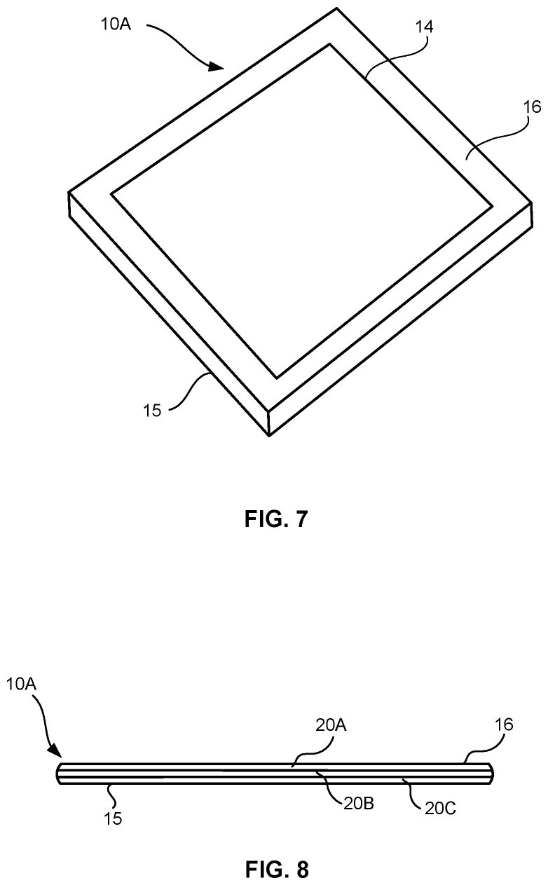

FIG. 7 depicts another preferred embodiment of the wax sheet 10A wherein a visual mark 14 is provided in the wax sheet inner surface 16 as an indication of the intended location of the vertex 18 (see FIG. 6) between the generally vertical wall 12 and the inner surface 16 of the beeswax tray 10B. The visual mark 14 is intended to assist the user with forming the generally vertical wall 12 during the transformation of the wax sheet 10A into the wax tray 10B. In that sense, the visual mark 14 identifies a location for a fold line for the formation of the generally vertical wall 12. In a preferred embodiment, the mark 14 may be any sort of indication that is visible to the user. More preferably, the mark 14 may be scored into the wax sheet 10A so the thickness T_{ws} of the wax sheet is reduced a relatively small amount (e.g., 0.1 inches) in the wax sheet. In another preferred embodiment, the mark 14 may simply be a visible (pigmented) line imparted on the wax in ink.

FIG. 8 depicts another preferred embodiment of the wax sheet 10A, in a which the wax sheet, which may comprise one or more layers 28A, 28B of wax, may further include a bottom layer 28C beneath the one or more overlying wax layers 28A, 28B. The bottom layer 28C provides a barrier layer impervious to the passage of the wax composition from the one or more wax layers 28A, 28B therethrough, thereby inhibiting the wax composition from contacting the floor (e.g. carpet, wood, tile) underlying the wax sheet 10A/wax tray 10B and potentially leaving a wax residue thereon.

In another embodiment, the absorbent pad 30 may include one or more wax layers consistent with the wax sheet of the prior embodiments. In other words, any teachings of the wax of the prior embodiments may be applied to the wax of the current embodiment.

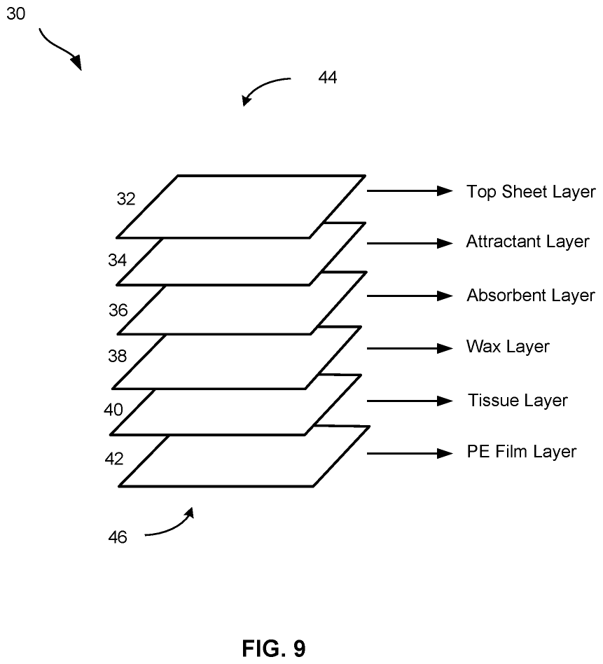

As shown by FIG. 9, the absorbent pad 30 may include a top (sheet) layer 32, that is designed to be porous to liquid waste. This may then be followed by one or more intermediate layers comprising an attractant layer 34 which is designed to attract the animal via smell or another stimulant, and an absorbent layer 36, which may be formed of pulp powder and/or a super absorbent polymer (SAP). It should also be appreciated that, optionally, additional layers may be present, such as an odor control layer or a scent masking layer which would mask or cover-up odors occurring after use.

The superabsorbent polymer may preferably have, for example, a retention absorbency in a range of 30 g/g to 45 g/g, an absorption capacity in a range of 55 g/g to 65 g/g (as measured in a 0.9% NaCl aqueous solution), an absorptive rate (e.g., a quantity of time to absorb 50, 100, or 150 milliliters of liquid such as a 0.9% NaCl aqueous solution) in a range of 15 seconds to 40 seconds, a moisture content in a range of 4% to 9%, a measure of residual acrylic acid monomers in a range of 15 parts-per-million (ppm) to 25 ppm, and a bulk density in a range of 0.6 g/ml to 0.85 g/ml. By way of further example, the absorbent layer 36 can include a superabsorbent polymer having a retention absorbency of 41 g/g, an absorption capacity of 60 g/g (as measured in a 0.9% NaCl aqueous solution), an absorptive rate of 29 seconds, a moisture content of 7.4%, a measure of residual acrylic acid monomers of 22 ppm, and a bulk density of 0.74 g/ml. By way of still further example, the absorbent layer 36 can include a superabsorbent polymer having a retention absorbency of 40 g/g, an absorption capacity of 60 g/g (as measured in a 0.9% NaCl aqueous solution), an absorptive rate of 30 seconds, a moisture content of 7.2%, a measure of residual acrylic acid monomers of 18 ppm, and a bulk density of 0.74 g/ml. Particle sizes of the superabsorbent polymer forming the absorbent layer 36 may measure less than 850 microns (μm). For example, between 80% and 90% of the particles may have a particle size measuring in a range of 180 μm to 500 μm.

The absorbent layer 36 may be followed by at least one wax layer 38. This may then be followed by a tissue layer 40 which preferably comprises of tissue paper. This may then be followed by a bottom (continuous non-perforated barrier film) layer 42. The film layer 42 may be a polyolefin type film layer, such as a polyethylene film layer. In any case, film layer 42 is preferably formed from or includes an impermeable film that prevents the flow of waste fluid from contacting the floor or other surface 10 upon which the absorbent pad may be placed. As such, it should be understood that absorbent pad 30 has an upper (fluid permeable/absorption) side 44 which is to face the animal during use thereof, and a lower (fluid impermeable/barrier) side 46 which is to face the underlying surface during use.

When the wax layer 38 is disposed between the other layers of the absorbent pad 30, it may be understood that the overlying layers 32, 34, 36 may inhibit the wax surfaces 16 from directly contact one another to adhere and bond to one another in the corners 20B of the wax tray 10B unless the overlying layers 32, 34 and 36 are removed from the absorbent pad 30 in the area of the generally vertical wall 12. The overlying layers 32, 34, 36 may be are removed from the absorbent pad 30 in the area of the generally vertical wall 12 by being completely separated (e.g. cut) from the absorbent pad or merely peeled back away from the wax surfaces 16 in the area of the generally vertical wall 12.

Alternatively, in certain embodiments the generally vertical wall 12 may be folded, bent or otherwise turned upright and the planar absorbent pad 30 formed into a tray without the vertical wax in the corners 20B necessarily being adhered and bonded to one another, particularly as the wax is malleable/ductile such that the generally vertical wall 12 will remain upright even if the wax in the corners 20B is not adhered and bonded to one another. When the wax layer 38 is formed into a wax tray, the absorbent pad 30 is correspondingly formed into an absorbent pad in the form of a tray.

Alternatively, in certain embodiments, the wax layer 38 may be used as the bottom layer of the absorbent pad, with layers 40 and 42 eliminated, or with layer 42 directly overlying adjacent wax layer 38.

While the present disclosure has been described in detail for the preferred embodiments described above, it will be understood that modifications can be made without departing from the scope of the disclosure herein.

What is claimed is:

1. A pet training pad system, comprising:
an absorbent pad; and
a wax sheet having a surface region which releasably engages with the absorbent pad.

2. The pet training pad system of claim 1 wherein the wax sheet comprises a plant-based wax, beeswax, or a hydrocarbon-based wax.

3. The pet training pad system of claim 2 wherein the plant-based wax comprises carnauba wax, soy wax, jojoba wax, candelilla wax or rice-bran wax.

4. The pet training pad system of claim 1 wherein the wax sheet has a melting point in a range of 35° C. to 100° C.

5. A pet training pad system, comprising:
an absorbent pad;
a wax sheet;
wherein the wax sheet is formable into a wax tray; and
wherein the absorbent pad is disposable in the wax tray.

6. The pet training pad system of claim 5, wherein the wax sheet comprises at least one edge region formable into a generally vertical wall of the wax tray.

7. The pet training pad system of claim 5, wherein the wax sheet comprises a plurality of edge regions, wherein each respective edge region is formable into a respective generally vertical wall of the wax tray.

8. The pet training pad system of claim 5, wherein the wax sheet comprises at least one edge region formable into at least one corner of the wax tray.

9. The pet training pad system of claim 8, wherein wax surfaces of the wax sheet are adhesively bondable to one another to form the at least one corner of the way tray.

10. The pet training pad system of claim 5, wherein the wax sheet comprises a plurality of edge regions, wherein each respective edge region is formable into a respective corner of the wax tray.

11. The pet training pad system of claim 10, wherein respective wax surfaces of the wax sheet are adhesively bondable to one another to form the respective corner of the wax tray.

12. The pet training pad system of claim 5, wherein the wax tray forms a releasable engagement with the absorbent pad.

13. The pet training pad system of claim 12, wherein the releasable engagement comprises a releasable adhesive bond.

14. The pet training pad system of claim 5, wherein the wax sheet formable into the wax tray comprises a plant-based wax, beeswax, or a hydrocarbon-based wax.

15. The pet training pad system of claim 14, wherein the plant-based wax comprises carnauba wax, soy wax, jojoba wax, candelilla wax or rice-bran wax.

16. The pet training pad system of claim 5, wherein the wax sheet formable into the wax tray has a melting point in the range of 35° C. to 100° C.

17. The pet training pad of claim 5, wherein the wax sheet formable into the wax tray includes one or more tackifier additives.

18. The pet training pad system of claim 5, wherein the wax sheet includes a visual mark that informs a user as to where the generally vertical wall intersects with the inner surface region.

19. A pet training absorbent pad, comprising:
a top layer;
a bottom layer;
at least one intermediate layers disposed between the top layer and the bottom layer;
wherein the at least one intermediate layer is a wax layer; and
wherein the wax layer is formable into a wax tray whereby the absorbent pad is correspondingly formed into an absorbent pad tray.

20. The absorbent pad of claim 19, wherein the adsorbent pad comprises at least a second intermediate layer, wherein the second intermediate layer is an absorbent layer disposed between the top layer and the wax layer.

21. The absorbent pad of claim 20, wherein the absorbent layer comprises super absorbent polymer and/or pulp.

22. A method of providing a pet training pad system comprising:
providing a wax sheet having at least two corner locations and at least one edge region; and
adhering together surfaces of the wax sheet at the at least two corner locations and forming a generally vertical wall at least two corner locations with the at least one edge region;
disposing a pet training pad on the wax sheet.
